(19) United States
(12) Patent Application Publication
(10) Pub. No.: US 2018/0109810 A1
(43) Pub. Date: Apr. 19, 2018

(54) Method and Apparatus for Reference Picture Generation and Management in 3D Video Compression

(71) Applicant: MEDIATEK INC., Hsin-Chu (TW)

(72) Inventors: Xiaozhong Xu, Stage College, PA (US); Shan Liu, San Jose, CA (US)

(21) Appl. No.: 15/730,842

(22) Filed: Oct. 12, 2017

Related U.S. Application Data
(60) Provisional application No. 62/408,870, filed on Oct. 17, 2016.

(51) Int. Cl. H04N 19/62; H04N 19/52; H04N 19/573; H04N 19/176

(52) U.S. Cl. CPC H04N 19/62; H04N 19/176; H04N 19/573; H04N 19/52

(57) ABSTRACT

Methods and apparatus for coding a 360-degree VR image sequence are disclosed. According to one method, input data associated with a current image in the 360-degree VR image sequence are received and also a target reference picture associated with the current image is received. An alternative reference picture is then generated by extending pixels from spherical neighboring pixels of one or more boundaries related to the target reference picture. A list of reference pictures including the alternative reference picture is provided for encoding or decoding the current image. The process of extending the pixels may comprise directly copying one pixel region, padding the pixels with one rotated pixel region, padding pixels with one mirrored pixel region, or a combination thereof.

### CROSS REFERENCE TO RELATED APPLICATIONS

The present invention claims priority to U.S. Provisional Patent Application Ser. No. 62/408,870, filed on Oct. 17, 2016. The U.S. Provisional patent application is hereby incorporated by reference in its entirety.

### FIELD OF THE INVENTION

The present invention relates to video coding. In particular, the present invention relates to techniques of generating and managing reference pictures for video compression of 3D video.

### BACKGROUND AND RELATED ART

The 360-degree video, also known as immersive video is an emerging technology, which can provide “feeling as sensation of present”. The sense of immersion is achieved by surrounding a user with wrap-around scene covering a panoramic view, in particular, 360-degree field of view. The “feeling as sensation of present” can be further improved by stereographic rendering. Accordingly, the panoramic video is being widely used in Virtual Reality (VR) applications. However, 3D videos require very large bandwidth to transmit and lots of storage space to store. Therefore, 3D videos are often transmitted and stored in a compressed format. Various techniques related to video compression and 3D formats are reviewed as follows.

Motion Compensation in HEVC Standard

The HEVC (High Efficiency Video Coding) standard, a successor to the AVC (Advanced Video Coding) standard was finalized in January, 2013. Since then, the development of new video coding technologies beyond HEVC is never-ending. The next generation video coding technologies aim at providing efficient solutions for compressing video contents in various formats such as YUV444, RGB444, YUV422 and YUV420. They are especially designed for high resolution videos, such as UHD (ultra-high definition) or 8K TV.

Nowadays video contents are often captured with camera motions, such as panning, zooming and tilting. Furthermore, not all the moving objects in a video fit into the translational motion assumption. It is observed that coding efficiency can sometimes be enhanced by effectively utilizing proper motion models such as affine motion compensation for compressing some video contents.

In HEVC, the use of Inter motion compensation can be in two different ways: explicit signaling or implicit signaling. In explicit signaling, the motion vector for a block (e.g. a prediction unit) is signaled by using a predictive coding method. The motion vector predictors may be derived from spatial or temporal neighbors of the current block. After prediction, the motion vector difference (MVD) is coded and transmitted. This mode is also referred as AMVP (advanced motion vector prediction) mode. In implicit signaling, one predictor from a predictor set is selected as the motion vector for current block (e.g. a prediction unit). In other words, no MVD or MV needs to be transmitted in the implicit mode. This mode is also referred as Merge mode. The forming of predictor set in Merge mode is also referred as Merge candidate list construction. An index, called Merge index, is signaled to indicate the selected predictor used for representing the MV for the current block.

With some previously decoded reference pictures provided, a prediction signal for predicting the samples in current picture can be generated by motion compensated interpolation, using the relationship between the current picture and those from the reference pictures and their motion fields.

In HEVC, multiple reference pictures may be used to predict blocks in the current slice. For each slice, one or two reference picture lists are established. Each list includes one or more reference pictures. The reference pictures listed in the reference picture list(s) are selected from a decoded picture buffer (DPB), which is used to store previously decoded pictures. At the beginning of decoding each slice, the reference picture list construction is performed to include the existing pictures in the DPB in the reference picture list. In case of scalable coding or screen content coding, besides the temporal reference pictures, some additional reference pictures may be stored for predicting the current slice. For example, the current decoded picture itself is stored in the DPB, together with other temporal reference pictures. For prediction using such a reference picture (i.e., the current picture itself), a specific reference index is assigned to signal the use of current picture as a reference picture. Or, in a scalable video coding case, when a special reference index is chosen, it is known that up-sampled base layer signals are used as prediction of the current samples in the enhanced layer. In this case, the up-sampled signals are not stored in the DPB. Instead, the up-sampled signals are generated when needed.

For a given coding unit, the coding block may be partitioned into one or more prediction units. In HEVC, different prediction unit partition modes, namely 2N×2N, 2N×N, N×2N, N×N, 2N×nU, 2N×nD, nL×2N and nR×2N, are supported. The binarization process for partition mode is listed in the following table for Intra and Inter modes.

TABLE 1

| | | | Bin string | | | |
|---|---|---|---|---|---|---|
| CuPredMode | | | log2CbSize > MinCbLog2SizeY | | log2CbSize == MinCbLog2SizeY | |
| [xCb][yCb] | part_mode | PartMode | !amp_enabled_flag | amp_enabled_flag | log2CbSize == 3 | log2CbSize > 3 |
| MODE_INTRA | 0 | PART_2Nx2N | — | — | 1 | 1 |
| | 1 | PART_NxN | — | — | 0 | 0 |
| MODE_INTER | 0 | PART_2Nx2N | 1 | 1 | 1 | 1 |
| | 1 | PART_2NxN | 01 | 011 | 01 | 01 |
| | 2 | PART_Nx2N | 00 | 001 | 00 | 001 |
| | 3 | PART_NxN | — | — | — | 000 |
| | 4 | PART_2NxnU | — | 0100 | — | — |
| | 5 | PART_2NxnD | — | 0101 | — | — |
| | 6 | PART_nLx2N | — | 0000 | — | — |
| | 7 | PART_nRx2N | — | 0001 | — | — |

Decoded Picture Buffer (DPB) Management and Screen Content Coding Extensions in HEVC

In HEVC, loop filtering operations, including deblocking and SAO (sample adaptive offset) filters, can be implemented either on a block-by-block basis (on the fly), or on a picture-by-picture basis after the decoding of the current picture. The filtered version of the current decoded picture, as well as some previously decoded pictures, is stored in the decoded picture buffer (DPB). When the current picture is decoded, a previously decoded picture can be used as a reference picture for motion compensation of a current picture only if it still remains in the DPB. Some non-reference pictures may stay in the DPB because they are behind the current picture in the display order. These pictures are waiting for output until all prior pictures in display order have been output. Once a picture becomes no longer used as a reference nor waiting for output, it will be removed from the DPB. The corresponding picture buffer is then emptied and opened up for storing future pictures. When a decoder starts to decode a picture, an empty buffer in the DPB needs to be available for storing this current picture. Upon completion of the current picture decoding, the current picture is marked as “used for short-term reference” and stored in the DPB as a reference picture for future usage. In any circumstance, the number of pictures in the DPB, including the current picture under decoding, must not exceed the indicated maximum DPB size capacity.

In order to keep the design flexibility in different HEVC implementations, the pixels used in the reconstructed decoded picture for the IBC mode are the reconstructed pixels prior to the loop filtering operations. The current reconstructed picture as reference picture for the IBC (Intra block copy) mode is referred as the “unfiltered version of the current picture” and the one after loop filtering operations is referred as the “filtered version of the current picture”. Again, depending on implementation, both versions of the current picture may exist at the same time.

Since the unfiltered version of the current picture can also be used as a reference picture in HEVC Screen Content Coding extensions (SCC), the unfiltered version of the current picture is also stored and managed in the DPB. This technique is referred as Intra-picture block motion compensation, Intra block copy mode or IBC for short. Therefore, when the IBC mode is enabled at the picture level, in addition to the picture buffer created for storing the filtered version of current picture, another picture storage buffer in the DPB may need to be emptied and made available for this reference picture before the decoding of the current picture. It is marked as “used for long-term reference picture”. Upon completion of the current picture decoding, including the loop filtering operations, this reference picture is removed from the DPB. Note that this extra reference picture is necessary only when either deblocking or SAO filtering operation is enforced for the current picture. When no loop filters are used in the current picture, there will be only one version of the current picture (i.e., unfiltered version) and this picture is used as the reference picture for the IBC mode.

The maximum capacity of the DPB has some connection to the number of temporal sub-layers allowed in the hierarchical coding structure. For example, the smallest picture buffer size needed is 5 to store temporal reference pictures for supporting 4-temporal-layer hierarchy, which is typically used in the HEVC reference encoder. Adding the unfiltered version of the current picture, the maximum DPB capacity for the highest spatial resolution allowed by a level will become 6 in the HEVC standard. In the presence of the IBC mode for decoding the current picture, the unfiltered version of current picture may take one picture buffer out from the existing DPB capacity. In HEVC SCC, the maximum DPB capacity for the highest spatial resolution allowed by a level is therefore increased to 7 from 6 to accommodate the additional reference picture for the IBC mode while maintaining the same hierarchical coding capabilities.

360 Degree Video Format and Coding

Virtual Reality and 360-degree video imposes enormous demands for processing speed and coding performance on codecs, using existing codecs for deployment of a high-quality VR video solution is almost impossible. The most common use case for VR and 360-degree video content consumption is that a viewer is looking at a small window (also called a viewport) inside an image that represents data captured from all sides. Viewer can watch this video on a smart phone app. Viewer may also watch the contents on a head-mounted display (HMD).

The viewport size is usually relatively small (e.g. HD). However, the video resolution corresponding to all sides can be significantly much higher (e.g. 8K). Delivery and decoding of an 8K video to a mobile device is unpractical in terms of latency, bandwidth and computational resources. As a result, there is a need for more efficient compression of VR contents in order to allow people to experience VR in high resolution with low latency and using most battery friendly algorithms.

The most common equirectangular projection method for 360-degree video applications is similar to a solution used in cartography to describe earth surface in a rectangular format on a plane. This type of projection has been widely used in computer graphics applications to represent textures for spherical objects and has gained recognition in gaming industry. Though it is perfectly compatible with a synthetic content in case of natural images, this format is facing several problems. Equirectangular projection is known for simple transformation process. However, different latitude lines have different stretching due to the transformation process. In this rendering method the equator line has minimal distortions or is free of distortions while poles areas have a maximum stretching and suffers from maximal distortions.

While a spherical surface natively represents 360-degree video content, the resolution preserving translation of an image from a spherical surface to the plane using equirectangular projection (ERP) method results in pixel count increase. In FIG. 1A and FIG. 1B, an example of equirectangular projection is shown. FIG. 1A illustrates an example of equirectangular projection that maps the grids on a globe 110 to rectangular grids 120. FIG. 1B illustrates some correspondences between the grids on a globe 130 and the rectangular grids 140, where a north pole 132 is mapped to line 142 and a south pole 138 is mapped to line 148. A latitude line 134 and the equator 136 are mapped to lines 144 and 146 respectively.

For ERP, the projection can be described mathematically as follows. The x coordinate of the 2D plane can be determined according to x=(λ−λ₀)cos φ₁. The y coordinate of the 2D plane can be determined according to y=(φ−φ₁). In the above equations, λ is the longitude of the location to project and φ is the latitude of the location to project, φ₁ is the standard parallel (north and south of the equator), where the scale of the projection is true, and λ₀ is the central meridian of the map.

Beside the ERP, there are many other projection formats widely used as shown in the following table.

TABLE 2

| Index | Projection format |
|---|---|
| 0 | Equirectangular (ERP) |
| 1 | Cubemap (CMP) |
| 2 | Equal-area (EAP) |
| 3 | Octahedron (OHP) |
| 5 | Icosahedron (ISP) |
| 7 | Truncated Square Pyramid (TSP) |
| 8 | Segmented Sphere Projection (SSP) |

The spherical format can also be projected to a platonic solid, such as cube, tetrahedron, octahedron, icosahedron and dodecahedron. FIG. 2 illustrates examples of platonic solid for cube, tetrahedron, octahedron, icosahedron and dodecahedron, where the 3D model, 2D model, number of vertexes, area ratio vs. sphere and ERP (equirectangular projection) are shown. Example of projecting a sphere to a cube is illustrated in FIG. 3A, where the six faces of a cube are labelled as A through F. In FIG. 3A, face F corresponds to the front; face A corresponds to the left; face C corresponds to the top; face E corresponds to the back; face D corresponds to the bottom; and face B corresponds to the right. Faces A, D and E are not visible from the perspective.

In order to feed the 360° video data into a video-codec conforming format, the input data have to be arranged in a plane (i.e., a 2-D rectangular shape). FIG. 3B illustrates an example of organizing the cube format into a 3×2 plane without any blank area. There may be other ordering arrangements of these six faces into the 3×2 shaped plane. FIG. 3C illustrates an example of organizing the cube format into a 4×3 plane with blank areas. In this case, the six faces are unfolded from the cube into a 4×3 shaped plane. Faces C, F and D are physically connected in the vertical direction of the 4×3 plane, where two faces share one common edge as they are on the cube (i.e., an edge between C and F and an edge between F and D). On the other hand, the four faces, F, B, E and A are physically connected as they are on the cube. The rest parts of the 4×3 plane are blank areas. The blank areas can be filled with black value by default. After decoding the 4×3 cubic image plane, pixels in the corresponding faces are used to reconstruct the data in the original cube. Pixels not in the corresponding faces (e.g. those filled with back values) can be discarded, or left there merely for the future reference purpose.

When motion estimation is applied to the projected 2D planes, a block in a current face may need to access reference data outside the current frame. However, the reference data outside the current face may not be available. Accordingly, the valid motion search range will be limited and compression efficiency will be reduced. It is desirable to develop techniques to improve coding performance associated with projected 2D planes.

### BRIEF SUMMARY OF THE INVENTION

Methods and apparatus for coding a 360-degree VR image sequence are disclosed. According to one method, input data associated with a current image in the 360-degree VR image sequence are received and also, a target reference picture associated with the current image is received. An alternative reference picture is then generated by extending pixels from spherical neighboring pixels of one or more boundaries related to the target reference picture. A list of reference pictures including the alternative reference picture is provided for encoding or decoding the current image. The process of extending the pixels may comprise directly copying one pixel region, padding the pixels with one rotated pixel region, padding pixels with one mirrored pixel region, or a combination thereof.

In the case of cubemap (CMP) format being used, the alternative reference picture can be generated by unfolding neighboring faces around four edges of a current face of the current image. The alternative reference picture may also be generated by extending pixels outside four edges of a current face of the current image using respective neighboring faces to generate one square reference picture without any blank area and the square reference picture is included within a window of the alternative reference picture. In another example, the alternative reference picture is generated by extending pixels outside four edges of the current face of the current image using respective neighboring faces to generate one rectangular reference picture to fill up a window of the alternative reference picture. In yet another example, the alternative reference picture is generated by projecting an extended area on a sphere to a projection plane corresponding to a current face, and wherein the extended area on the sphere encloses a corresponding area on the sphere projected to the current face.

In the case of equirectangular (ERP) format being used, the alternative reference picture can be generated by shifting the target reference picture horizontally by 180 degrees. In another example, the alternative reference picture is generated by padding first pixels outside one vertical boundary of the target reference picture from second pixels inside another vertical boundary of the target reference picture. In this case, the alternative reference picture can be implemented virtually based on the target reference picture stored in a decoded picture buffer by accessing the target reference picture using a modified offset address.

The alternative reference picture can be stored at location N in one reference picture list, where N is a positive integer. The alternative reference picture may also be stored at a last location in one reference picture list. If the target reference picture corresponds to a current decoded picture, the alternative reference picture can be stored in a second to last position in a reference picture list while the current decoded picture is stored at the last position in the reference picture list. If the target reference picture corresponds to a current decoded picture, the alternative reference picture can be stored in a last position in a reference picture list while the current decoded picture is stored at a second to last position in the reference picture list.

The alternative reference picture can be stored in a target position after short-term reference pictures and before long-term reference pictures in the reference picture list. The alternative reference picture can be stored in a target position in the reference picture list as indicated by high-level syntax.

A variable can be signaled or derived to indicate whether the alternative reference picture is used as one reference picture in the list of reference pictures. A value of the variable can be determined according to one or more signaled high-level flags. A value of the variable can be determined according to a number of available picture buffers in decoded picture buffer (DPB) when the number of available picture buffers is at least two for non-Intra-Block-Copy (non-IBC) coding mode or at least three for Intra-Block-Copy (IBC) coding mode. A value of the variable can be determined according to whether there exists one reference picture in decoded picture buffer (DPB) to generate the alternative reference picture. In this case, the method may further comprise allocating one picture buffer in decoded picture buffer (DPB) for storing the alternative reference picture before decoding the current image if the variable indicates that the alternative reference picture is used as one reference picture in the list of reference pictures. The method may further comprise removing the alternative reference picture from the DPB or storing the alternative reference picture for decoding future pictures after decoding the current image.

### BRIEF DESCRIPTION OF THE DRAWINGS

FIG. 1A illustrates an example of equirectangular projection that maps the grids on a globe to rectangular grids.

FIG. 1B illustrates some correspondences between the grids on a globe and the rectangular grids, where a north pole 132 is mapped to the top line and a south pole is mapped to the bottom line.

FIG. 2 illustrates examples of platonic solid for cube, tetrahedron, octahedron, icosahedron and dodecahedron, where the 3D model, 2D model, number of vertexes, area ratio vs. sphere and ERP (equirectangular projection) are shown.

FIG. 3A illustrates examples of projecting a sphere to a cube, where the six faces of a cube are labelled as A through F.

FIG. 3B illustrates an example of organizing the cube format into a 3×2 plane without any blank area.

FIG. 3C illustrates an example of organizing the cube format into a 4×3 plane with blank areas.

FIG. 4 illustrates an example of the geographical relationship among the selected main face (i.e., the front face, F in FIG. 3A) and its four neighboring faces (i.e., top, bottom, left and right) for the cubemap (CMP) format.

FIG. 5 illustrates an example of generating an alternative reference picture for the cubemap (CMP) format by extending neighboring faces of the main face to form a square or a rectangular extended reference picture.

FIG. 6A illustrates an example of generating an alternative reference picture for the cubemap (CMP) format by projecting a larger area than the target sphere area corresponding to the main face.

FIG. 6B illustrates an example of the alternative reference picture for the cubemap (CMP) format for a main face according to the projection method in FIG. 6A.

FIG. 7 illustrates an example of generating an alternative reference picture by unfolding neighboring faces of a main face for the cubemap (CMP) format.

FIG. 8 illustrates an example of generating an alternative reference picture for the equirectangular (ERF) format by shifting the reference picture horizontally by 180 degrees.

FIG. 9 illustrates an example of generating an alternative reference picture for the equirectangular (ERF) format by padding first pixels outside one vertical boundary of the target reference picture from second pixels inside another vertical boundary of the target reference picture.

FIG. 10 illustrates an exemplary flowchart for a video coding system for a 360-degree VR image sequence incorporating an embodiment of the present invention, where an alternative reference picture is generated and included in the list of reference pictures.

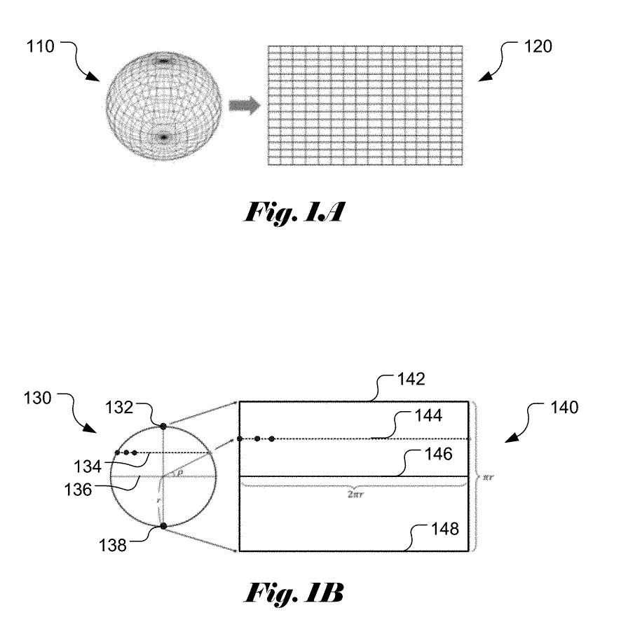

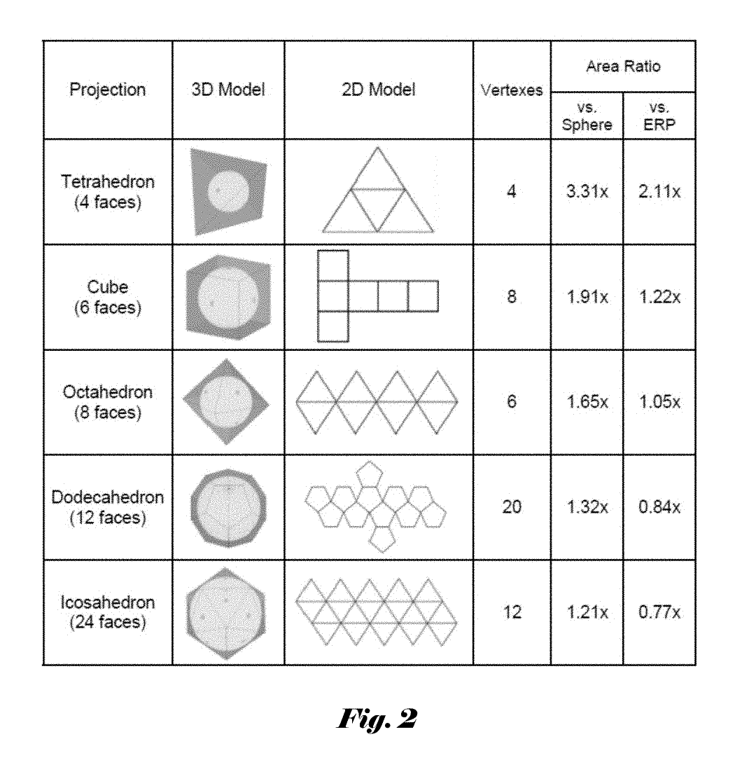

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

As mentioned before, when motion estimation is applied to the projected 2D planes, a block in a current face may need to access reference data outside the current frame. However, the reference data outside the current face may not be available. In order to improve coding performance associated with projected 2D planes, reference data generation and management techniques are disclosed to enhance reference data availability.

For any pixel in a 360-degree picture data, the pixel is always surrounded by some other pixels. In other words, there is no picture boundary or empty area in the 360-degree picture. When such video data on a sphere domain is projected into a 2D plane, some discontinuity may be introduced. Also, some blank areas without any meaningful pixels are introduced. For example, in the ERP format, if an object moves across the left boundary of the picture, it will appear from the right boundary of the succeeding pictures. In another example, in the CMP format, if an object moves across the left boundary of one face, it will appear from another boundary of another face depending on the face arrangement in the 2-D image plane. These issues will cause difficulty for traditional motion compensation, where the motion field is assumed to be continuous.

In the present invention, pixels that are disconnected in the 2-D image plane are assembled together according to the geographical relationship on the spherical domain to form a better reference for coding of future pictures or future areas of current picture. One or more reference pictures are referred as “generated reference picture” or “alternative reference picture” in this disclosure.

Generation of New Reference Picture

For the CMP format, there are six faces to be coded in a current picture. For each face, a number of different methods can be used to generate a reference picture for predicting pixels in a given face in the current picture. A face to be coded is regarded as the “main face”.

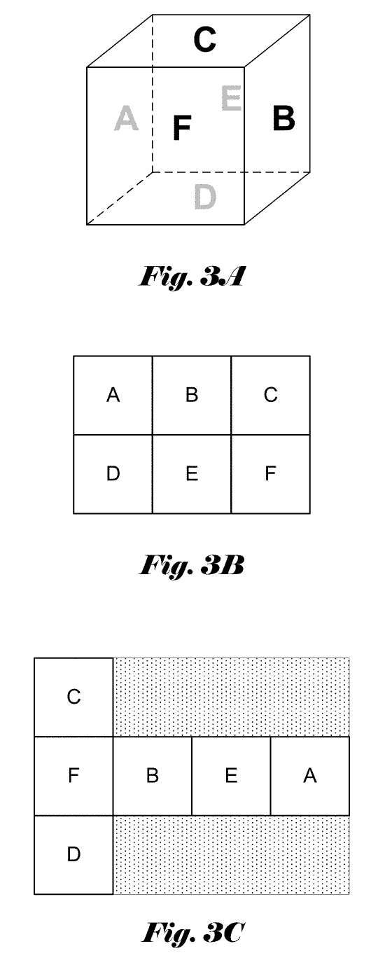

In a first method, the main face in a reference picture is used as the base to create the new generated reference picture (i.e., the alternative reference picture). This is done by extending the main face using pixels from its neighboring faces in the reference picture. FIG. 4 illustrates an example of the geographical relationship among the selected main face (i.e., the front face, F in FIG. 3A) and its four neighboring faces (i.e., top, bottom, left and right faces) as indicated in block 410. In block 420 on the right hand side, an example of extending the main face in a 2-D plane is shown, where each of the four neighboring faces are stretched into a trapezoidal shape and padded to one side of the main face to form the extended reference picture in square.

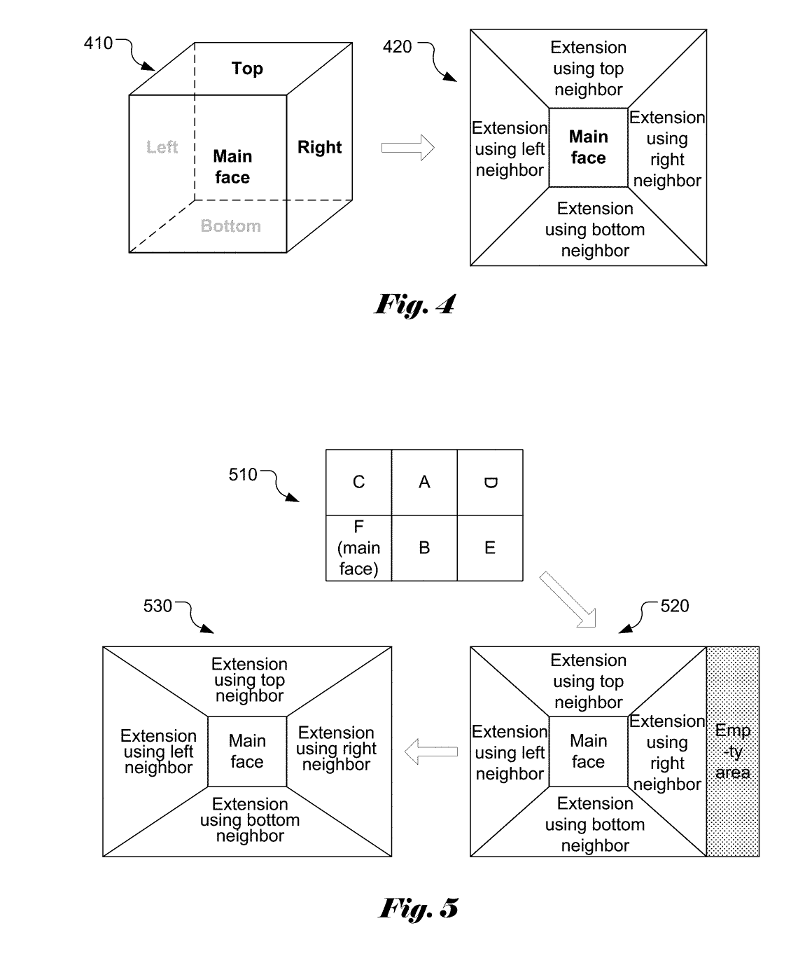

The height and width of the extended neighbors around the main face are determined by the size of the current picture, which is further decided by the packing method of this CMP projection. For example, in FIG. 5, picture 510 corresponds to a 3×2 packed plane. Therefore, the extended reference area as discussed above cannot exceed the size of the reference picture, as shown in picture 520 of FIG. 5. In another example, the neighboring faces are further expended to fill up the whole rectangular picture area as shown in picture 530. While the front face is used as the main face in the above example, any other face may be used as the main face and corresponding neighboring faces can be extended to form the extended reference picture.

According to another method, each pixel on a face is created by extending a line from the origin O of the sphere 610 to one point on the sphere and then to the projection plane. For example in FIG. 6A, point P1 on the sphere is projected onto the plane at point P. P is within the bottom face, which is the main face in this example. Accordingly, point P will be in the bottom face of the cubic format. For another point T1 on the sphere, which is projected onto point T in the bottom plane and point T is located outside the main face. Therefore, in traditional cubic projection, point T belongs to another face, which belongs to a neighboring face of the main face. According to the present method, the main face 612 is extended to cover a larger area 614 as shown in FIG. 6B. The extended face can be a square or a rectangular. Pixels in the extended main face are created using the same projection rule as that for pixels in the main face. For example, for point T in the extended main face, it is projected from the point T1 on the sphere. The extended main face in the reference picture can be used to predict the corresponding main face in the current picture. The size of the extended main face in the reference picture is decided by the size of the reference picture, and further decided by the packing method of CMP format.

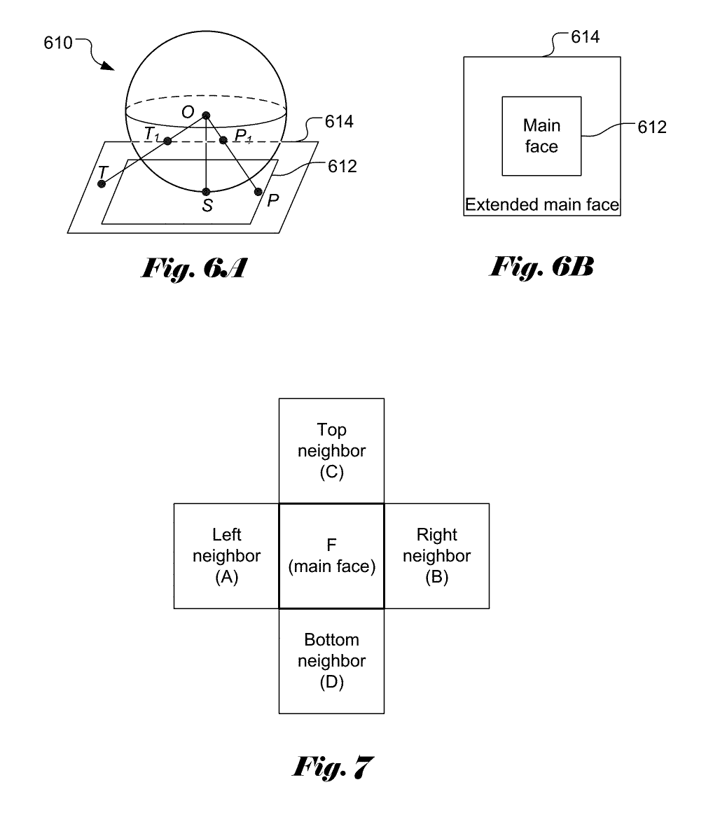

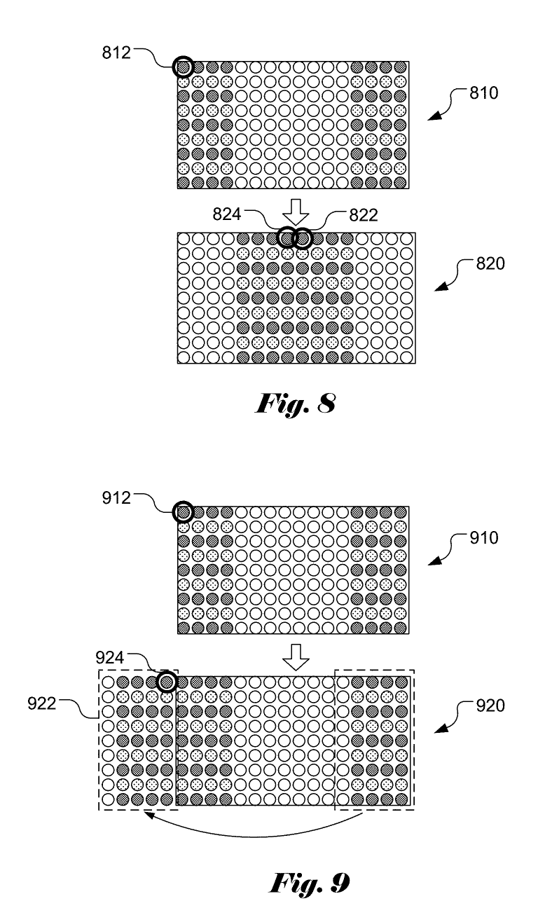

According to yet another method, the generated reference picture for predicting the current face (i.e., the main face) is created by simply unfolding the cubic faces with the main face in the center. The four neighboring faces are located around the four edges of the main face, as shown in FIG. 7, where the front face F is shown as the main face and designations of neighboring face (i.e., A, B, C and D) follow the convention in FIG. 3A.

For the ERP format, the generated reference picture can be made by shifting the original ERP projection picture according to one embodiment. In one example as shown in FIG. 8, the original picture 810 is shifted horizontally to the right by 180 degrees (i.e., half of the picture width) to generate a reference picture 820. Also, the original reference picture may be shifted by other degrees and/or other directions. Accordingly, when a motion vector of a block in the current picture points to this generated reference picture (i.e., alternative reference picture), an offset should be applied to the motion vector in the amount of the shifted number of pixels from the original picture. For example, the top-left position in the original picture 810 of FIG. 8 is designated as A(0, 0). When point A (812) moves to the left by one integer position as indicated by MV=(−1, 0), it does not have correspondence if a conventional reference picture is used. However, in the shifted reference picture (i.e., picture 820 in FIG. 8), the corresponding position (822) for (0, 0) in the original picture is now (image_width/2, 0), where image_width is the width of the ERP picture. Therefore, an offset (image_width/2, 0) will be applied to the motion vector (−1, 0). For the original pixel A, the resulting reference pixel location B (824) in the generated reference picture is calculated as: location of A+MV+offset=(0, 0)+(−1, 0)+(image_width/2, 0)=(image_width/2−1, 0). Therefore, enabling the use of such generated reference picture together with the offset value can be done at high level syntax, such as using an SPS (sequence parameter set) flag.

In another method, a reference picture is generated by padding the existing reference picture boundary. The pixels used for padding the picture boundary may come from the other side of picture boundary, which are originally connected to each other. This new reference picture can be physically allocated with a memory, or virtually used by proper calculation of the address. When a virtual reference picture is used, an offset is still applied to the MV pointing to a reference location that is beyond the picture boundary. For example, in FIG. 9, the top-left position 912 in the original picture 910 is A(0, 0); and when it moves to the left by one integer position (indicated by MV=(−1, 0)), the reference location becomes (−1, 0), which is beyond the original picture boundary. By padding, this location now has a valid pixel 924 as the reference pixel (pixels in dotted box 922 in FIG. 9) to form a reference picture 920. Alternatively, an offset of image_width can be applied to horizontal locations that go beyond left picture boundary without using a physical memory to store such a padded reference picture to mimic the padding effect. In this example, the reference location for A will become location of A+MV+offset=(0, 0)+(−1, 0)+(image_width, 0)=(image_width−1, 0). Similarly, an offset of (−image_width) is applied to horizontal locations that go beyond the right picture boundary.

Enabling this offset for reference locations beyond picture boundary can be indicated at high level syntax, such as using an SPS flag or a PPS (picture parameter set) flag.

While extended reference picture generation methods have been disclosed above for the CMP and ERP formats, similar methods can be used to generate the new reference picture (either physically or virtually) for coding of 360 degree video sequences with other projection formats (e.g. ISP (Icosahedron Projection with 20 faces) and OHP (Octahedron Projection with 8 faces).

Other than the above mentioned methods for creating pixels in the generated reference pictures, methods for properly filtering or processing of these pixels to reduce compensation distortion can be applied. For example, in FIG. 7, pixels in left neighbor are derived from left neighboring face of the main face. These left neighboring pixels can be further processed and/or filtered to generate a reference picture with lower distortion for predicting pixels in the current face of current picture.

Reference Picture Management for Generated Reference Picture(s)

Whether to put this generated reference picture into the decoded picture buffer (DPB) can be a sequence level and/or picture level decision. In particular, a picture level flag (e.g. GeneratedPictureInDPBFlag) can be signaled or derived to make the decision regarding whether it is necessary to reserve an empty picture buffer and put such a picture into the DPB. One or some combinations of the following methods can be used to determine the value of GeneratedPictureInDPBFlag:
In one method, GeneratedPictureInDPBFlag is determined by some high level syntax (e.g. picture level or above) to indicate the use of alternative reference picture as disclosed above. Only when it is signaled to indicate that the generated picture may be used as a reference picture, it is possible that GeneratedPictureInDPBFlag is equal to 1.
In another method, GeneratedPictureInDPBFlag is determined by the existence of available picture buffers in the DPB. For example, only when there is at least one reference picture available in the DPB, the “new” reference picture can be generated. Therefore, the minimum requirement for the DPB is to contain 3 pictures (i.e., one existing reference picture, one generated picture and one current decoded picture). When the maximum DPB size is smaller than 3, GeneratedPictureInDPBFlag shall be 0. In case that the current picture is used as a reference picture (i.e., Intra block motion compensation being used) and the unfiltered version of current picture is stored in the DPB as an extra version of current decoded picture, then the maximum DPB size is required to be 4 to support both Intra block copy and the generated reference picture.
In the above method, in general, each generated reference picture requires one picture buffer in the DPB; for creating the generated picture (s), at least one reference picture should already exist in the DPB; for storing the current decoded picture (prior to loop filtering) for Intra picture block motion compensation purpose, one picture buffer is needed in the DPB; in addition, the current decoded picture needs to be stored in the DPB during decoding. All these will be counted for the total number of pictures in the DPB, which will be capped by the DPB size. If there are other type(s) of reference pictures in the DPB, these reference pictures also need to be counted towards the DPB size.

When GeneratedPictureInDPBFlag is true, at the beginning of decoding the current picture, the following process can be performed:
If Intra picture block motion compensation is not used for the current picture, or when Intra block motion compensation is used but only one version of the current decoded picture is needed, the DPB operation needs to empty two picture buffers, one for storing the current decoded picture and another for storing the generated reference picture;
If Intra picture block motion compensation is used for the current picture and two versions of the current decoded picture are needed, the DPB operation needs to empty three picture buffers for storing the current decoded pictures (i.e., two versions) and the generated reference picture.

When GeneratedPictureInDPBFlag is false, at the beginning of decoding the current picture, one or two empty picture buffers are needed depending on the usage of Intra picture block motion compensation and the existence of two versions of the current decoded picture.

When GeneratedPictureInDPBFlag is true, after decoding the current picture is completed, the following process can be performed:
In one embodiment, the DPB operation needs to empty the picture buffer for storing the generated reference picture. In other words, the generated reference picture cannot be used by other future picture as a reference picture
In another embodiment, the DPB operations are applied to this generated reference picture in a similar way as other reference pictures. It removes this reference picture only when it is not marked as “used for reference”. Note that a generated reference picture cannot be used for output (e.g. display buffer).

The use of generated picture as a reference picture for temporal prediction may be determined by one of or a combination of following factors:
A high level flag (e.g. in SPS and/or PPS, such as sps_generated_refpic_enabled_flag and/or pps_generated_ref_pic_enabled_flag) to indicate the use of generated_reference picture for the current sequence or picture,
If this generated_reference picture is to be created and stored in the DPB, and the above mentioned “GeneratedPictureInDPBFlag” is equal to 1 (i.e., true)

If it is decided to use such a generated picture as a reference picture regardless whether it is stored in the DPB or not, the generated picture is put into one or both of the reference picture lists for predicting the blocks in the current slice/picture. Several methods are disclosed to modify the reference picture list construction as follows:
In one embodiment, this generated picture is put into position N of a reference picture list. N is an integer number, ranging from 0 to the number of allowed reference pictures for the current slice. In case of multiple generated reference pictures, N indicates the position of the first one. Others follow the first one in a consecutive order.
In another embodiment, this generated picture is put into the last position of a reference picture list. In case of multiple generated reference pictures, all of them are put in the last positions in a consecutive order.
In another embodiment, if current decoded picture is used as a reference picture (i.e., Intra picture block motion compensation), the generated reference picture is put into the second to last position while the current decoded picture is put into the last position. In case of multiple generated reference pictures, all of them are put in the second to last position in a consecutive order while the current decoded picture is put into the last position.
In another embodiment, if current decoded picture is used as a reference picture (Intra picture block motion compensation), the current decoded picture is put into the second to last position while the generated reference picture is put in the last position. In case of multiple generated reference pictures, all of them are put into the last positions in a consecutive order.
In another embodiment, this generated picture is put in between short-term and long-term reference pictures (i.e., after short-term reference pictures and before long-term reference pictures) in a reference picture list. In case the current decoded picture is also put into this position, their order can be either way (generated picture first then current decoded picture, or the reverse). In case of multiple generated reference pictures, all of them are put together in between short-term and long-term reference pictures. The current decoded picture itself can be put either behind of before all of them.
In another embodiment, this generated picture is put into a position of a reference picture list suggested by high level syntax (picture level, or sequence level). When high level syntax is not present, a default position, such as the last position or the position between short-term and long-term reference pictures, is used. In case of multiple generated reference pictures, the signaled or suggested position indicates the position of the first one. Others follow the first one in a consecutive order.

Before decoding a current picture, if one or more generated reference pictures are allowed, a few picture level decisions need to be made as follows:
Specify which reference picture(s) in the DPB to be used as the base to create the generated reference picture(s). This can be done by explicitly signaling the position of such a reference picture in the reference picture list. This can also be done implicitly without signaling by choosing a default position. For example, the reference picture with smallest POC difference relative to the current picture in List 0 can be chosen.
Create one or multiple generated reference picture based on selected reference picture(s) existing in the DPB.
Remove all the previously generated reference pictures that are marked as “not used for reference” for decoding current picture.

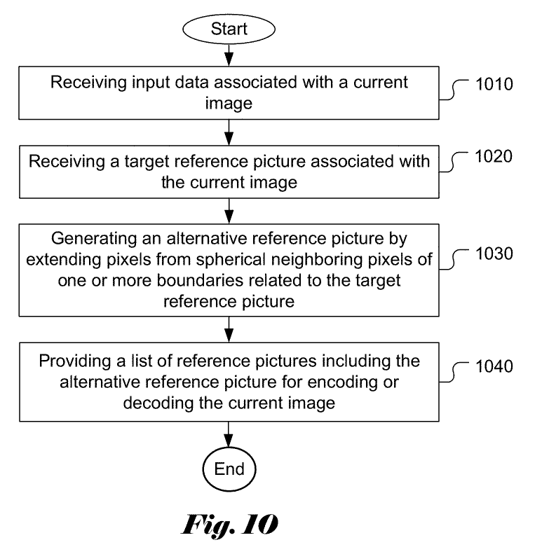

FIG. 10 illustrates an exemplary flowchart for a video coding system for a 360-degree VR image sequence incorporating an embodiment of the present invention, where an alternative reference picture is generated and included in the list of reference pictures. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, input data associated with a current image in the 360-degree VR image sequence are received in step 1010. A target reference picture associated with the current image is received in step 1020. The target reference picture may correspond to a conventional reference picture for the current image. An alternative reference picture (i.e., the new generated reference picture) is generated by extending pixels from spherical neighboring pixels of one or more boundaries related to the target reference picture in step 1030. A list of reference pictures including the alternative reference picture is provided for encoding or decoding the current image in step 1040.

The above flowcharts may correspond to software program codes to be executed on a computer, a mobile device, a digital signal processor or a programmable device for the disclosed invention. The program codes may be written in various programming languages such as C++. The flowchart may also correspond to hardware based implementation, where one or more electronic circuits (e.g. ASIC (application specific integrated circuits) and FPGA (field programmable gate array)) or processors (e.g. DSP (digital signal processor)).

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be a circuit integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of coding a 360-degree VR image sequence, the method comprising:
receiving input data associated with a current image in the 360-degree VR image sequence;
receiving a target reference picture associated with the current image;
generating an alternative reference picture by extending pixels from spherical neighboring pixels of one or more boundaries related to the target reference picture; and
providing a list of reference pictures including the alternative reference picture for encoding or decoding the current image.

2. The method of claim 1, wherein said extending the pixels comprises directly copying one pixel region, padding the pixels with one rotated pixel region, padding pixels with one mirrored pixel region, or a combination thereof.

3. The method of claim 1, wherein the current image is in a cubemap (CMP) format; and the alternative reference picture is generated by unfolding neighboring faces around four edges of a current face of the current image.

4. The method of claim 1, wherein the current image is in a cubemap (CMP) format; and the alternative reference picture is generated by extending pixels outside four edges of a current face of the current image using respective neighboring faces to generate one square reference picture without any blank area and including said one square reference picture within a window of the alternative reference picture.

5. The method of claim 1, wherein the current image is in a cubemap (CMP) format; and the alternative reference picture is generated by extending pixels outside four edges of a current face of the current image using respective neighboring faces to generate one rectangular reference picture to fill up a window of the alternative reference picture.

6. The method of claim 1, wherein the current image is in a cubemap (CMP) format; and the alternative reference picture is generated by projecting an extended area on a sphere to a projection plane corresponding to a current face, and wherein the extended area on the sphere encloses a corresponding area on the sphere projected to the current face.

7. The method of claim 1, wherein the current image is in an equirectangular (ERP) format; and the alternative reference picture is generated by shifting the target reference picture horizontally by 180 degrees.

8. The method of claim 1, wherein the current image is in an equirectangular (ERP) format; and the alternative reference picture is generated by padding first pixels outside one vertical boundary of the target reference picture from second pixels inside another vertical boundary of the target reference picture.

9. The method of claim 8, wherein the alternative reference picture is implemented virtually based on the target reference picture stored in a decoded picture buffer by accessing the target reference picture using a modified offset address.

10. The method of claim 1, wherein the alternative reference picture is stored at location N in one reference picture list, and wherein N is a positive integer.

11. The method of claim 1, wherein the alternative reference picture is stored at a last location in one reference picture list.

12. The method of claim 1, wherein if the target reference picture corresponds to a current decoded picture, the alternative reference picture is stored in a second to last position in a reference picture list while the current decoded picture is stored at a last position in the reference picture list.

13. The method of claim 1, wherein if the target reference picture corresponds to a current decoded picture, the alternative reference picture is stored in a last position in a reference picture list while the current decoded picture is stored at a second to last position in the reference picture list.

14. The method of claim 1, wherein the alternative reference picture is stored in a target position after short-term reference pictures and before long-term reference pictures in a reference picture list.

15. The method of claim 1, wherein the alternative reference picture is stored in a target position in a reference picture list as indicated by high-level syntax.

16. The method of claim 1, wherein a variable is signaled or derived to indicate whether the alternative reference picture is used as one reference picture in the list of reference pictures.

17. The method of claim 16, wherein a value of the variable is determined according to one or more signaled high-level flags.

18. The method of claim 16, wherein a value of the variable is determined according to a number of available picture buffers in decoded picture buffer (DPB) when the number of available picture buffers is at least two for non-Intra-Block-Copy (non-IBC) coding mode or at least three for Intra-Block-Copy (IBC) coding mode.

19. The method of claim 16, wherein a value of the variable is determined according to whether there exists one reference picture in decoded picture buffer (DPB) to generate the alternative reference picture.

20. The method of claim 16, further comprises allocating one picture buffer in decoded picture buffer (DPB) for storing the alternative reference picture before decoding the current image if the variable indicates that the alternative reference picture is used as one reference picture in the list of reference pictures.

21. The method of claim 20, further comprising removing the alternative reference picture from the DPB or storing the alternative reference picture for decoding future pictures after decoding the current image.

22. An apparatus for coding a 360-degree VR image sequence, the apparatus comprising one or more electronic circuits or processor arranged to:
receive input data associated with a current image in the 360-degree VR image sequence;
receive a target reference picture associated with the current image;
generate an alternative reference picture by extending pixels from spherical neighboring pixels of one or more boundaries related to the target reference picture; and
provide a list of reference pictures including the alternative reference picture for encoding or decoding the current image.
